(19) United States
(12) Patent Application Publication
(10) Pub. No.: US 2014/0096004 A1
(43) Pub. Date: Apr. 3, 2014

(54) BROWSER, AND VOICE CONTROL METHOD AND SYSTEM FOR BROWSER OPERATION

(71) Applicant: TENCENT TECHNOLOGY (SHENZHEN) COMPANY LIMITED, Shenzhen City (CN)

(72) Inventors: Xiaobo ZHOU, Shenzhen City (CN); Tiange SI, Shenzhen City (CN); Yuguo LIU, Shenzhen City (CN)

(73) Assignee: TENCENT TECHNOLOGY (SHENZHEN) COMPANY LIMITED, Shenzhen City (CN)

(21) Appl. No.: 14/098,134

(22) Filed: Dec. 5, 2013

Related U.S. Application Data
(63) Continuation of application No. PCT/CN2012/086047, filed on Dec. 6, 2012.

(30) Foreign Application Priority Data
Apr. 19, 2012 (CN) 201210118223.9

(51) Int. Cl. G06F 3/16

(52) U.S. Cl. CPC G06F 3/167
USPC 715/728

(57) ABSTRACT

A voice control method and system for browser operations are described. The method comprises the steps of: receiving an inputted voice control command; the command field value found in the predetermined web page template is the template entry of the voice control command wherein the predetermined web page template includes a plurality of template entries and each of the template entries contains an element field, a command field, and an operation field; and searching an element in a current web page wherein the element corresponds to the value of the element field in the template entry such that the element executes the operation corresponding to the operation field. The present method performs the voice control according to the web page content, thus further improving the voice experience effect upon the user.

### CROSS REFERENCE TO RELATED APPLICATION

This application is a continuation of International Application No. PCT/CN2012/086047, filed on Dec. 6, 2012, which claims priority to Chinese patent application No. 201210118223.9, filed on Apr. 19, 2012, the content of which are incorporated herein by reference in their entirety.

### FIELD OF THE INVENTION

The present invention relates to a browser of an electronic apparatus, and more particularly to a browser apparatus, and voice control method and system for browser operation used in the electronic apparatus.

### BACKGROUND OF THE INVENTION

Currently, the voice techniques, including the modes of the voice inputting method and voice control command, used in the browser products is widely applied to the electronic apparatus. On one hand, the mode of the voice inputting method may be a voice search manner and voice input for documents, on the other hand, the mode of the voice control command may be a voice control command for controlling the next web page or previous web page of the browser operations.

While performing the voice control command mode, the voice is firstly converted into text and the converted text may be regarded as a command of the browser, which is an interaction manner, i.e. termed as user interface (UI), of the browser products controlled by the voice of the user.

Conventionally, the mode of the voice control command in the browser product is limited. For example, the mode of the voice control command is a general control manner which is irrelevant to the web page content. The general control manner is only suitable to the browser operations, e.g. web page turning, forwarding next web page, backwarding web page and opening website in the browser product, of each kind of web page. In other words, the mode of the voice control command only aims to the functions of the browser product and irrelevant to the web page content.

Consequently, there is a need to develop a novel voice control manner of the mode of the voice control command to solve the problem of the general control manner which is irrelevant to the web page content.

### SUMMARY OF THE INVENTION

One objective of the present invention is to provide a browser apparatus, and voice control method and system for browser operation used in the electronic apparatus to solve the problem of the general control manner which is irrelevant to the web page content.

According to the above objective, the present invention sets forth a browser apparatus, and voice control method and system for browser operation used in the electronic apparatus.

In one embodiment of the present invention, the voice control method for browser operations performed in an electronic apparatus and the method comprises the steps of: determining whether a current web page is registered in a predetermined white list wherein the predetermined white list comprises a plurality of web pages which can be actuated by a voice control for the browser operations; receiving a voice control command if the current web page is registered in the predetermined white list; comparing an element field corresponding to the voice control command in the current web page; acquiring an operation field corresponding to the element field; and controlling the current web page for executing one of the browser operations corresponding to the operation field.

In one preferred embodiment, before the step of receiving the voice control command if the current web page is registered in the predetermined white list, the voice control method further comprises the steps of: pre-storing a plurality of template entries wherein each of the template entries comprises an one-to-one relationship between the element field and the operation field; and during the step of acquiring the operation field corresponding to the element field, further comprising the step of: comparing the operation field corresponding to the element field in the each of the template entries.

In one preferred embodiment, a plurality of template entries are pre-stored and each of the template entries comprises an one-to-one relationship between the element field, the command field and the operation field, further comprising: during the step of comparing the element field corresponding to the voice control command in the current web page, further comprising the step of: comparing the command field corresponding to the voice control command; and during the step of acquiring the operation field corresponding to the element field, further comprising the step of: comparing the element field according to the command field; and comparing the operation field according to the element field.

In one preferred embodiment, before the step of receiving the voice control command, the voice control method further comprises the step of: predetermining the white list wherein the white list comprises a plurality of websites of the web pages which are actuated by the voice control for the browser operations.

In one embodiment of the present invention, a voice control method for browser operations performed in an electronic apparatus, the method comprising the steps of: receiving a voice control command; acquiring a command field corresponding to the voice control command; searching one of a plurality of template entries in a web page template according to the command field wherein each of the template entries comprises an one-to-one relationship between an element field, the command field and an operation field; and searching an element in a current web page wherein the element corresponds to a value of the element field in the one of the template entries such that the element executes an operation corresponding to the operation field.

In one preferred embodiment, before the step of receiving the voice control command, further comprising the step of: determining whether the current web page is registered in a predetermined white list wherein the predetermined the white list comprises a plurality of websites corresponding to a plurality of web pages which are actuated by the voice control for the browser operations; and receiving the voice control command if the current web page is registered in the predetermined white list.

In one preferred embodiment, before the step of receiving the voice control command, the voice control method further comprises the step of: predetermining a white list for registering the current web page, actuated by the voice control for the browser operations, to the white list.

In one preferred embodiment, the value of the element field is an identification attribute of the element.

In one embodiment of the present invention, a voice control system for browser operations performed in an electronic apparatus, the system comprising: a voice-receiving unit, for receiving a voice control command; a template entry-searching unit, for searching one of a plurality of template entries in a web page template according to a command field, wherein each of the template entries comprises an one-to-one relationship between an element field, the command field and an operation field; and an operation-executing unit, for searching an element in a current web page wherein the element corresponds to a value of the element field in the one of the template entries such that the element executes an operation corresponding to the operation field.

In one preferred embodiment, the voice control system further comprises: a website-determining unit, for determining whether the current web page is registered in a predetermined white list wherein the predetermined the white list comprises a plurality of websites corresponding to a plurality of web pages which are actuated by the voice control for the browser operations; and a voice control-actuating unit, for controlling the voice-receiving unit to receive the voice control command for actuating the voice control system if the website-determining unit determines that the current web page is registered in the predetermined white list.

In one preferred embodiment, the voice control system further comprises: a white list generation unit for registering the current web page, actuated by the voice control for the browser operations, to the predetermined white list.

In one preferred embodiment, the value of the element field is an identification attribute of the element.

In one embodiment, the browser apparatus having a voice control system for browser operations, the voice control system comprising: a voice-receiving unit, for receiving a voice control command; a template entry-searching unit, for searching one of a plurality of template entries in a web page template according to a command field, wherein each of the template entries comprises an one-to-one relationship between an element field, the command field and an operation field; and an operation-executing unit, for searching an element in a current web page wherein the element corresponds to a value of the element field in the one of the template entries such that the element executes an operation corresponding to the operation field.

In one preferred embodiment, the voice control system further comprises: a website-determining unit, for determining whether the current web page is registered in a predetermined white list wherein the predetermined the white list comprises a plurality of websites corresponding to a plurality of web pages which are actuated by the voice control for the browser operations; and a voice control-actuating unit, for controlling the voice-receiving unit to receive the voice control command for actuating the voice control system if the website-determining unit determines that the current web page is registered in the predetermined white list.

In one preferred embodiment, the voice control system further comprises: a white list generation unit for registering the current web page, actuated by the voice control for the browser operations, to the predetermined white list.

In one preferred embodiment, the browser apparatus further comprises: the value of the element field is an identification attribute of the element.

The present invention provides the web page with the voice control commands so that the command field value found in the predetermined web page template is the template entry of the voice control command after the browser apparatus receives the voice control commands from the web page. The predetermined web page template includes a plurality of template entries and each of the template entries contains an element field, a command field, and an operation field. The voice control method and system for browser operations is capable of searching an element in a current web page wherein the element corresponds to the value of the element field in one of the template entries such that the element executes the operation corresponding to the operation field. The present invention performs the voice control modes on the content, e.g. message-posting, Weibo forwarding and comment-making operations, of the web page so that the content of the web page is controlled by the voice control command.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a flow chart of a voice control method for browser operations performed in an electronic apparatus according to the first embodiment of the present invention;

FIG. 2 is a schematic view of a first interaction dialog in a web page according to the first embodiment of the present invention;

FIG. 3 is a schematic view of a second interaction dialog in a web page according to the first embodiment of the present invention;

FIG. 4 is a schematic view of a third interaction dialog in a web page according to the fourth embodiment of the present invention;

FIG. 5 is a flow chart of a voice control method for browser operations performed in the electronic apparatus according to the second embodiment of the present invention;

FIG. 6 is a schematic view of a voice control system for browser operations performed in an electronic apparatus according to the third embodiment of the present invention; and

FIG. 7 is a schematic view of a voice control system for browser operations performed in an electronic apparatus according to the fourth embodiment of the present invention.

### DETAILED DESCRIPTION OF THE PREFERRED EMBODIMENTS

In one embodiment of the present invention, a web page with the specific content which is compatible to web 2.0 for example includes a uniform frame structure such that the user can submit more and more web page content. For example, the website, http://t.qq.com, with the uniform frame structure can be used to perform some browser operations, e.g. message-forwarding, Weibo sending and comment-making operated in the uniform frame structure. The present invention provides the web page with the voice control commands so that the command field value found in the predetermined web page template is the template entry of the voice control command after the browser apparatus receives the voice control commands from the web page. The predetermined web page template includes a plurality of template entries and each of the template entries contains an element field, a command field, and an operation field. The voice control method and system for browser operations is capable of searching an element in a current web page wherein the element corresponds to the value of the element field in one of the template entries such that the element executes the operation corresponding to the operation field.

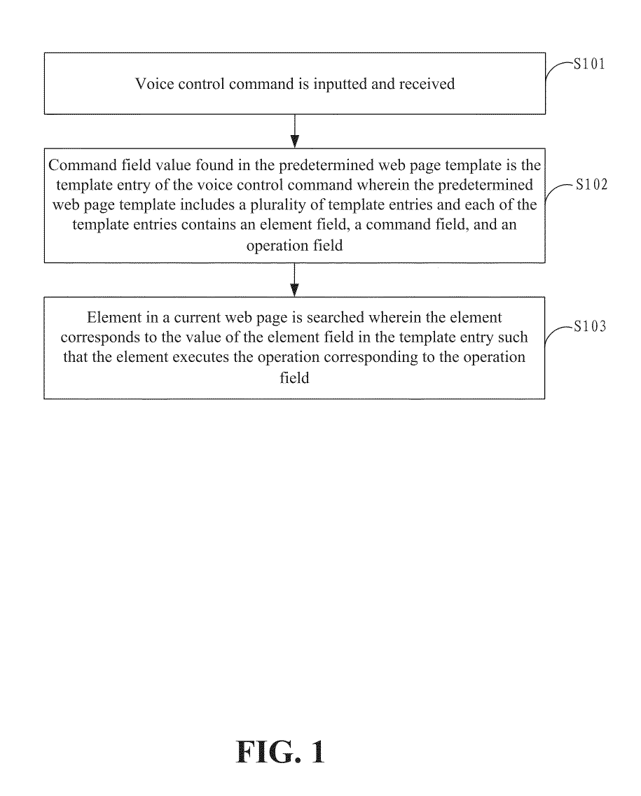

FIG. 1 is a flow chart of a voice control method for browser operations performed in an electronic apparatus according to the first embodiment of the present invention. In this embodiment, the browser apparatus actuates the voice control function in advance so that the browser apparatus can receive the voice control command inputted by the user for controlling the element in the web page based on the voice control command.

In the step S101, the voice control command is inputted and received.

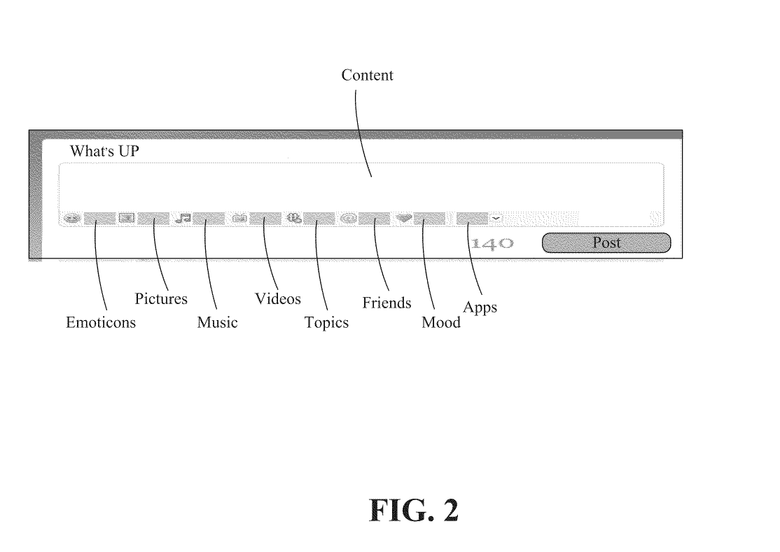

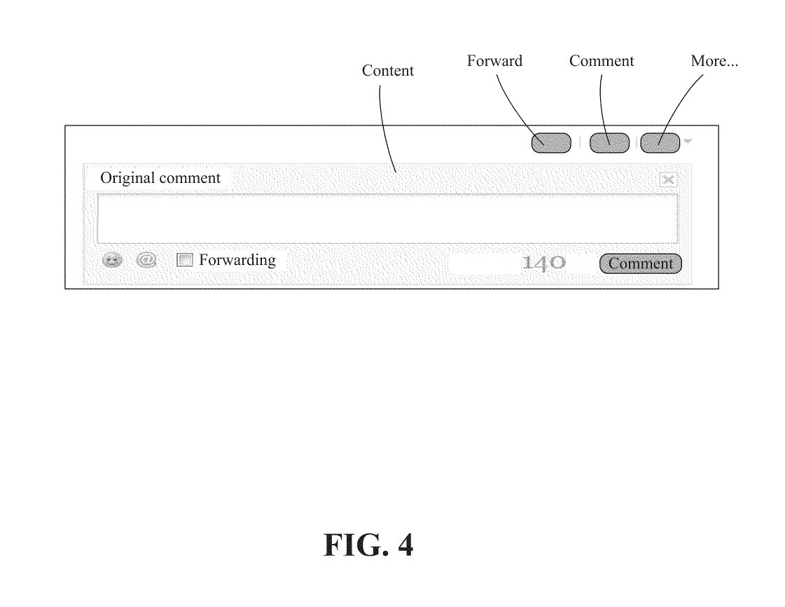

In this embodiment, the user inputs a website in the website field of the browser apparatus and the browser apparatus displays the content corresponding to the website of the web page for the user. Specifically, the user inputs a command corresponding to an operation button of the web page in a voice-inputting manner. After the browser apparatus receives the voice control command, the browser apparatus is capable of controlling the function of the operation button. In one case, the browser apparatus provides some interaction dialogs in the web page. For example, the website, http://t.qq.com, includes a plurality of interaction dialogs shown in FIGS. 2, 3 and 4 having some browser operations, e.g. message-posting, Weibo forwarding and comment-making operations. The user can input text messages, and/or forward messages and make comments instead of the text inputting in the interaction dialogs.

The method for implementing the interactions on the web page of the browser apparatus by the voice control command comprises the following descriptions:

When the user has no need to input text messages into interaction dialogs shown in FIGS. 2, 3 and 4 or the text messages has inputted into interaction dialogs, the operation is complete after the user clicks the button operations corresponding to the browser operations, e.g. “message-posting”, “Weibo forwarding” and “comment-making” operations.

In the present invention, the voice control commands are used to control the button operations corresponding to the browser operations, e.g. message-posting, Weibo forwarding and comment-making operations. In other words, when the user speaks the voice of “message-posting”, “Weibo forwarding” and/or “comment-making”, the message-posting, Weibo forwarding and comment-making operations in the browser apparatus are triggered as if the user employs the mouse or keyboard to click the buttons on the web page.

In comparison to the conventional voice control command, the message-posting, Weibo forwarding and comment-making operations in the present invention serve as the functions of the content of the web page. The present invention performs the voice control modes on the content, e.g. message-posting, Weibo forwarding and comment-making operations, of the web page.

In the step S102, the command field value found in the predetermined web page template is the template entry of the voice control command wherein the predetermined web page template includes a plurality of template entries and each of the template entries contains an element field, a command field, and an operation field.

In this embodiment, a web page template defines the events, i.e. operations, corresponding to the elements respectively in the content of web page so that the events are controlled by the voice control command.

The web page template includes a plurality of template entries corresponding to the different elements wherein the template entries define the control aspects of the elements on the web page. Three basic fields of the template entry are represented by the format: <element, command, operation> to indicate the element in the web page. In one case, the value of the element field is an identification attribute of the element wherein the identification (ID) attribute of each element in the web page, e.g. Hypertext Markup Language (HTML) format, is unique.

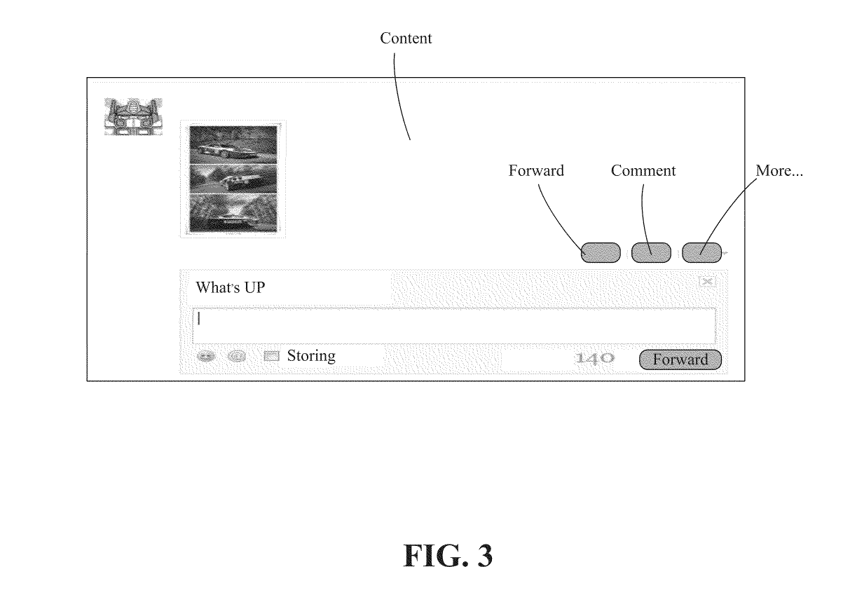

For example, on the website, http://t.qq.com as shown in FIG. 3, the ID of the element corresponding to the button “forwarding” is represented by “ID=‘mybuttonid’”, the event, i.e. operation, is represented by “onclick=‘forwardweibo’”, and thus the template entry is represented by “<‘mybuttonid’, ‘forwarding’, ‘forwardweibo’>”.

In the step S103, an element in a current web page is searched wherein the element corresponds to the value of the element field in the template entry such that the element executes the operation corresponding to the operation field.

For example, on the website, http://t.qq.com as shown in FIG. 3, the browser apparatus finds the template entry “<‘mybuttonid’, ‘forwarding’, ‘forwardweibo’>” in the web page template based on the voice control command after the user inputs the voice control command “forwarding”. Then, the button on the web page corresponding to the element ID ‘mybuttonid’ is found so that the found button performs the operation ‘forwardweibo’.

According to the aforementioned descriptions, the user inputs the voice control command by the voice inputting method. The browser apparatus detects the voice control command and the voice control command controls the operation corresponding to the element when the voice control command is compared to be identical to the command performed by the corresponding to element on the content of web page. The present invention performs the voice control modes by using the commands on the content of the web page.

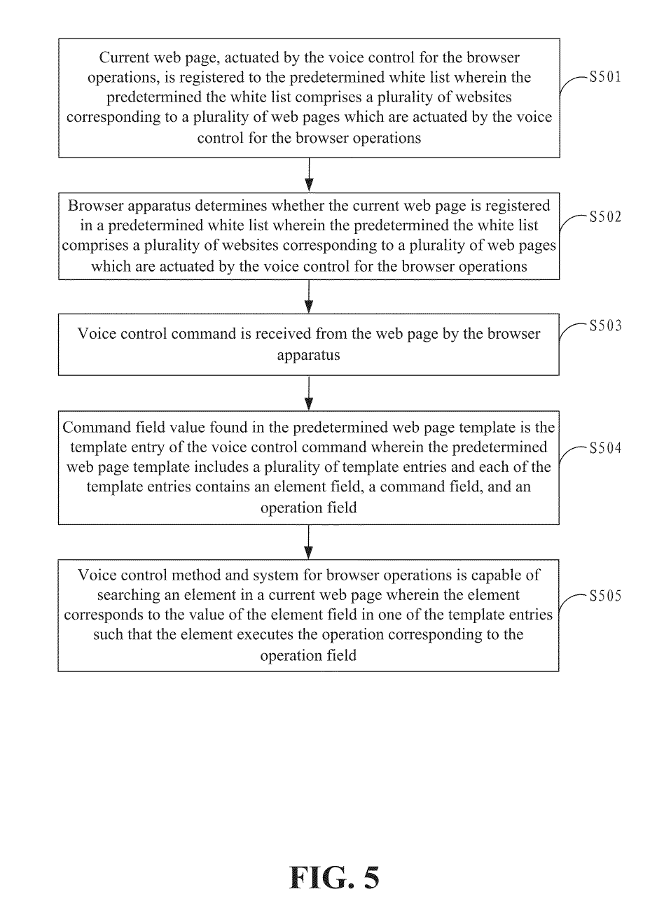

FIG. 5 is a flow chart of a voice control method for browser operations performed in the electronic apparatus according to the second embodiment of the present invention.

In the step S501, the current web page, actuated by the voice control for the browser operations, is registered to the predetermined white list wherein the predetermined the white list comprises a plurality of websites corresponding to a plurality of web pages which are actuated by the voice control for the browser operations.

In the second embodiment, since the voice control method of the present invention aims to the content of the web page, it is necessary to map the operations on the web page to the voice control commands so that the web page, http://t.qq.com, is constructed based on the voice control commands in advance. It is required that the current web page, actuated by the voice control for the browser operations, is registered to the predetermined white list if the voice control is employed. After the website of the web page is added to the predetermined white list, the function of voice control is actuated by the browser apparatus so that the inputted voice control commands is capable of controlling the element of the content of the web page. In comparison to the first embodiment, the second embodiment advantageously actuates the web pages registered in the predetermined white list to save the resource of the electronic apparatus in order to increase the browsing speed of the web page.

In the step S502, the browser apparatus determines whether the current web page is registered in a predetermined white list wherein the predetermined the white list comprises a plurality of websites corresponding to a plurality of web pages which are actuated by the voice control for the browser operations. The browser apparatus actuates the function of voice control so that the voice control command is inputted by the user if the current web page is registered in the predetermined white list.

In this embodiment, the user inputs the website in the website field and enters the website. The browser apparatus then determines whether a current web page is registered in a predetermined white list wherein the predetermined white list comprises a plurality of web pages which can be actuated by a voice control for the browser operations. If the current web page is registered in a predetermined white list, the function of voice control is actuated.

In the step S503, a voice control command is received from the web page by the browser apparatus.

In the step S504, the command field value found in the predetermined web page template is the template entry of the voice control command wherein the predetermined web page template includes a plurality of template entries and each of the template entries contains an element field, a command field, and an operation field.

In the step S505, the voice control method and system for browser operations is capable of searching an element in a current web page wherein the element corresponds to the value of the element field in one of the template entries such that the element executes the operation corresponding to the operation field.

In this embodiment, the steps S503 through S505 is similar to the steps S101 through S103 in the first embodiment of the present invention. Thus, the detailed descriptions are omitted herein.

In the second embodiment, it is required that the current web page, actuated by the voice control for the browser operations, is registered to the predetermined white list. After the website of the web page is added to the predetermined white list, the function of voice control is actuated by the browser apparatus so that the inputted voice control commands is capable of controlling the element of the content of the web page. In comparison to the first embodiment, the second embodiment advantageously actuates the web pages registered in the predetermined white list to save the resource of the electronic apparatus in order to increase the browsing speed of the web page.

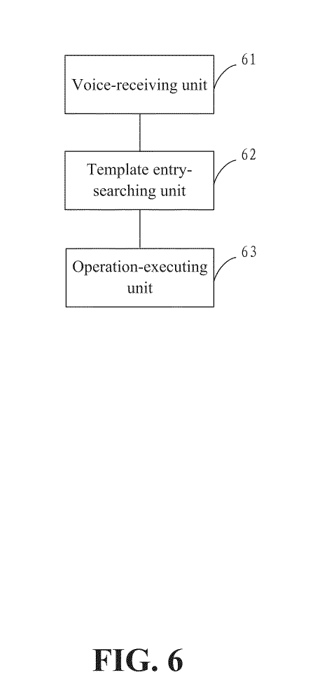

FIG. 6 is a schematic view of a voice control system for browser operations performed in an electronic apparatus according to the third embodiment of the present invention. The browser apparatus having a voice control system for browser operations. The voice control system comprises a voice-receiving unit 61, a template entry-searching unit 62 and an operation-executing unit 63.

The voice-receiving unit 61 receives a voice control command. The template entry-searching unit 62 searches one of a plurality of template entries in a web page template according to a command field, wherein each of the template entries comprises a one-to-one relationship between an element field, the command field and an operation field. The operation-executing unit 63 searches an element in a current web page wherein the element corresponds to a value of the element field in the one of the template entries such that the element executes an operation corresponding to the operation field.

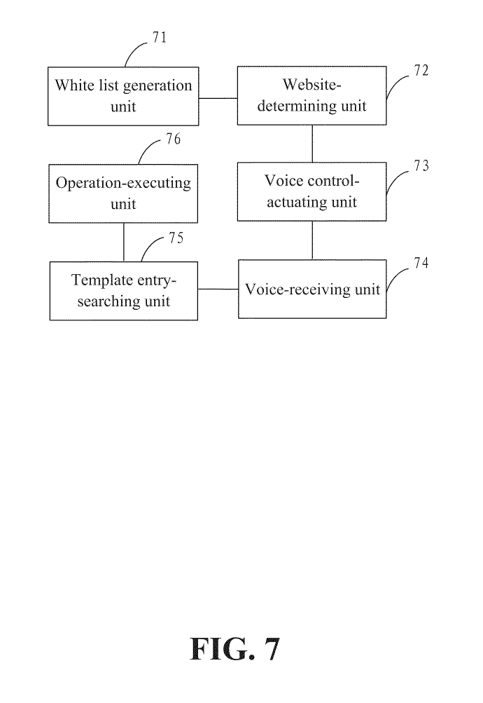

FIG. 7 is a schematic view of a voice control system for browser operations performed in an electronic apparatus according to the fourth embodiment of the present invention. The voice control system for browser operations is software programs, hardware components, firmware programs and/or the combinations performed within the browser apparatus. The voice control system comprises a white list generation unit 71, a website-determining unit 72, a voice control-actuating unit 73, a voice-receiving unit 74, a template entry-searching unit 75 and an operation-executing unit 76.

The white list generation unit 71 registers the current web page, actuated by the voice control for the browser operations, to the predetermined white list wherein the predetermined the white list comprises a plurality of websites corresponding to a plurality of web pages which are actuated by the voice control for the browser operations.

The website-determining unit 72 determines whether the current web page is registered in a predetermined white list wherein the predetermined the white list comprises a plurality of websites corresponding to a plurality of web pages which are actuated by the voice control for the browser operations.

The voice control-actuating unit 73 controls the voice-receiving unit to receive the voice control command for actuating the voice control system if the website-determining unit determines that the current web page is registered in the predetermined white list.

The voice-receiving unit 74 receives a voice control command.

The template entry-searching unit 75 searches one of a plurality of template entries in a web page template according to a command field, wherein each of the template entries comprises an one-to-one relationship between an element field, the command field and an operation field. The operation-executing unit 76 searches an element in a current web page wherein the element corresponds to a value of the element field in the one of the template entries such that the element executes an operation corresponding to the operation field.

The implements of the above-mentioned units are described in the first and second embodiments and are omitted herein. Person skilled in the art should be noted that the browser apparatus, and voice control method and system for browser operation used in the electronic apparatus in the above embodiments may be employed by hardware components. Further, the browser apparatus, and voice control method and system for browser operation used in the electronic apparatus which are stored in the computer readable media, such as read only memory (ROM), random access memory (RAM), hard disk drive and optical disk.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A voice control method for browser operations performed in an electronic apparatus, the method comprising the steps of:
determining whether a current web page is registered in a predetermined white list wherein the predetermined white list comprises a plurality of web pages which can be actuated by a voice control for the browser operations;
receiving a voice control command if the current web page is registered in the predetermined white list;
comparing an element field corresponding to the voice control command in the current web page;
acquiring an operation field corresponding to the element field; and
controlling the current web page for executing one of the browser operations corresponding to the operation field.

2. The voice control method of claim 1, before the step of receiving the voice control command if the current web page is registered in the predetermined white list, further comprising the step of:
pre-storing a plurality of template entries wherein each of the template entries comprises an one-to-one relationship between the element field and the operation field; and
during the step of acquiring the operation field corresponding to the element field, further comprising the step of:
comparing the operation field corresponding to the element field in the each of the template entries.

3. The voice control method of claim 1, wherein a plurality of template entries are pre-stored and each of the template entries comprises an one-to-one relationship between the element field, the command field and the operation field, further comprising:
during the step of comparing the element field corresponding to the voice control command in the current web page, further comprising the step of:
comparing the command field corresponding to the voice control command; and
during the step of acquiring the operation field corresponding to the element field, further comprising the step of:
comparing the element field according to the command field; and
comparing the operation field according to the element field.

4. The voice control method of claim 1, before the step of receiving the voice control command, further comprising the step of: predetermining the white list wherein the white list comprises a plurality of websites of the web pages which are actuated by the voice control for the browser operations.

5. A voice control method for browser operations performed in an electronic apparatus, the method comprising the steps of:
receiving a voice control command;
acquiring a command field corresponding to the voice control command;
searching one of a plurality of template entries in a web page template according to the command field wherein each of the template entries comprises an one-to-one relationship between an element field, the command field and an operation field; and
searching an element in a current web page wherein the element corresponds to a value of the element field in the one of the template entries such that the element executes an operation corresponding to the operation field.

6. The voice control method of claim 5, before the step of receiving the voice control command, further comprising the step of:
determining whether the current web page is registered in a predetermined white list wherein the predetermined the white list comprises a plurality of websites corresponding to a plurality of web pages which are actuated by the voice control for the browser operations; and
receiving the voice control command if the current web page is registered in the predetermined white list.

7. The voice control method of claim 5, before the step of receiving the voice control command, further comprising the step of: predetermining a white list for registering the current web page, actuated by the voice control for the browser operations, to the white list.

8. The voice control method of claim 5, wherein the value of the element field is an identification attribute of the element.

9. A voice control system for browser operations performed in an electronic apparatus, the system comprising:
a voice-receiving unit, for receiving a voice control command;
a template entry-searching unit, for searching one of a plurality of template entries in a web page template according to a command field, wherein each of the template entries comprises an one-to-one relationship between an element field, the command field and an operation field; and
an operation-executing unit, for searching an element in a current web page wherein the element corresponds to a value of the element field in the one of the template entries such that the element executes an operation corresponding to the operation field.

10. The voice control system of claim 9, further comprising:
a website-determining unit, for determining whether the current web page is registered in a predetermined white list wherein the predetermined the white list comprises a plurality of websites corresponding to a plurality of web pages which are actuated by the voice control for the browser operations; and
a voice control-actuating unit, for controlling the voice-receiving unit to receive the voice control command for actuating the voice control system if the website-determining unit determines that the current web page is registered in the predetermined white list.

11. The voice control system of claim 10, further comprising: a white list generation unit for registering the current web page, actuated by the voice control for the browser operations, to the predetermined white list.

12. The voice control system of claim 9, wherein the value of the element field is an identification attribute of the element.

13. A browser apparatus having a voice control system for browser operations, the voice control system comprising:
a voice-receiving unit, for receiving a voice control command;
a template entry-searching unit, for searching one of a plurality of template entries in a web page template according to a command field, wherein each of the template entries comprises an one-to-one relationship between an element field, the command field and an operation field; and
an operation-executing unit, for searching an element in a current web page wherein the element corresponds to a value of the element field in the one of the template entries such that the element executes an operation corresponding to the operation field.

14. The browser apparatus of claim 13, wherein the voice control system further comprises:
a website-determining unit, for determining whether the current web page is registered in a predetermined white list wherein the predetermined the white list comprises a plurality of websites corresponding to a plurality of web pages which are actuated by the voice control for the browser operations; and
a voice control-actuating unit, for controlling the voice-receiving unit to receive the voice control command for actuating the voice control system if the website-determining unit determines that the current web page is registered in the predetermined white list.

15. The browser apparatus of claim 13, wherein the voice control system further comprises:
a white list generation unit for registering the current web page, actuated by the voice control for the browser operations, to the predetermined white list.

16. The browser apparatus of claim 13, wherein the value of the element field is an identification attribute of the element.
